(19) United States
(12) Patent Application Publication
(10) Pub. No.: US 2005/0107519 A1
(43) Pub. Date: May 19, 2005

(54) Process for the preparation of stable polymer concentrates

(75) Inventors: Matthias Loeffler, Niedemhausen (DE); Roman Morschhaeuser, Mainz (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 10/817,371

(22) Filed: Apr. 2, 2004

(30) Foreign Application Priority Data
Apr. 3, 2003 (DE) 10315182.6

(51) Int. Cl. C08L 39/00

(52) U.S. Cl. 524/555

(57) ABSTRACT

A process for the preparation of concentrates which comprise 10 to 80% by weight of a copolymer based on acryloyldimethyltauric acid or salts thereof, 20 to 90% by weight of a solvent or solvent mixture and/or one or more emulsifiers and 0 to 30% by weight of water is described. The concentrates can, for example, be used for the preparation of cosmetic, pharmaceutical and dermatological preparations.

The present invention relates to a process for the preparation of concentrates from copolymers based on acryloyidimethyltauric acid or salts thereof and linear and/or cyclic N-vinylcarboxamides.

WO 02/44231 describes a new class of polymers based on acryloyldimethyltauric acid or salts thereof. These polymers cover broad application properties and can be used as thickener, consistency-imparting agent, emulsifier, dispersant, slip-agent, conditioner and/or stabilizer in cosmetic, dermatological and pharmaceutical compositions.

The copolymers based on acryloyldimethyltauric acid or salts thereof preferably prepared by precipitation polymerization and corresponding to the prior art are pulverulent substances with application disadvantages resulting therefrom. Pulverulent substances, in principle, hold the risk of dust explosion, and in addition the storage stability of the powders is adversely affected as a result of hygroscopicity.

For the processing and/or use of the pulverulent products, the dissolution operation (the polymers are preferably incorporated into aqueous media) is in most cases very time-consuming. The dissolution operation of the pulverulent products can, depending on the size of the batch, take an hour or more. In addition, incomplete dissolution/swelling of the pulverulent products is often observed, which leads to a reduction in the quality and stability of the end formulation (formation of lumps). In addition, the processing and/or use of the pulverulent products requires particular stirring and dispersion devices in order to dissolve, or to suspend, respectively, the polymers based on acryloyldimethyltauric acid or salts thereof.

The object of the present invention was to develop a one-pot process for the preparation of polymer concentrates comprising copolymers based on acryloyldimethyltauric acid or salts thereof. The polymer concentrates should, when present in highly concentrated liquid or liquid-disperse form, i.e. when the highest possible polymer content arises, have a low viscosity combined with high stability of the solution or dispersion.

Surprisingly, it has been found that storage-stable and thermostable concentrates of copolymers described below based on acryloyidimethyltauric acid or salts thereof can be prepared by adding a solvent after the polymerization reaction whose boiling point is higher than the boiling point of the polymerization media, solvent or solvent mixture used for the polymerization, and then removing the lower-boiling polymerization medium, solvent or solvent mixture, optionally at a pressure which is lowered relative to atmospheric pressure, and optionally at a temperature which is increased relative to room temperature (25° C.).

The invention provides a process for the preparation of concentrates in liquid or liquid-disperse form comprising
10 to 80% by weight, preferably 20 to 60% by weight, particularly preferably 30 to 40% by weight, of a copolymer comprising
1 to 50% by weight of the repeat structural unit of the formula (1) 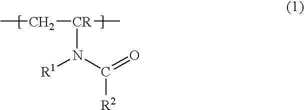
   where R, R¹ and R² may be identical or different and are hydrogen, a linear or branched alkyl group having in each case 1 to 30, preferably 1 to 20, in particular 1 to 12, carbon atoms or a linear or branched alkenyl group having in each case 2 to 30, preferably 2 to 20, in particular 2 to 12, carbon atoms, or R¹ and R² together are a C₂-C₉-alkylene group,
b) 49.99 to 98.99% by weight of the repeat structural unit of the formula (2) 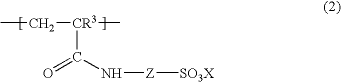
   in which R³ is hydrogen, methyl or ethyl, Z is C₁-C₈-alkylene and X is an ammonium, alkali metal or alkaline earth metal ion, and
c) 0.01 to 8% by weight, preferably 0.01 to 5% by weight, of crosslinking structures which have come from monomers with at least two olefinic double bonds,
II) 20 to 90% by weight, preferably 30 to 80% by weight, particularly preferably 40 to 60% by weight, of one or more emulsifiers and/or a solvent or solvent mixture, and
III) 0 to 30% by weight, preferably 0 to 10% by weight, particularly preferably 0 to 5% by weight, of water,
   wherein the concentrate is prepared by
a) free-radical copolymerization of components a), b) and c), preferably by solution polymerization, gel polymerization, by an emulsion process, precipitation process, high-pressure process or suspension process in a polymerization medium which behaves largely inertly with regard to free-radical polymerization reactions and permits the formation of high molecular weights, preferably water and lower, tertiary alcohols or hydrocarbons having 3 to 30 carbon atoms, particularly preferably tert-butanol,
b) addition of a higher-boiling solvent or solvent mixture and/or one or more emulsifiers and optionally water to the mixture of polymer and polymerization medium, where the boiling point of the higher-boiling solvent or solvent mixture is at least 10° C. higher than that of the polymerization medium used for the polymerization and
c) removal of the lower-boiling polymerization medium, optionally at a pressure which is lowered relative to atmospheric pressure, and optionally at a temperature which is increased relative to room temperature.

In a preferred embodiment, the liquid or liquid-disperse concentrates prepared by the process according to the invention comprise copolymers which consist essentially of the structural units a), b) and c).

Preferably, the liquid or liquid-disperse concentrates prepared according to the process of the invention comprise copolymers consisting of 2 to 30, in particular 3 to 15% by weight of structural units of the formula (1), preferably derived from N-vinylpyrrolidone, 69.5 to 97.5% by weight, in particular 84.5 to 96.5% by weight, of structural units of the formula (2), preferably derived from the ammonium salt of 2-acrylamido-2-methylpropanesulfonic acid and 0.2 to 3% by weight, in particular 0.5 to 2% by weight, of crosslinking structures which have come from monomers with at least two olefinic double bonds. The copolymers can also comprise mixtures of different structural units within the formula (1), preferably mixtures of monomers with cyclic and open carboxamide groups. The mixing ratio may vary here within any desired limits.

Crosslinking structures which have come from monomers with at least two olefinic double bonds are preferably derived from acrylic or methacrylic allyl ester, dipropylene glycol diallyl ether, polyglycol diallyl ether, triethylene glycol divinyl ether, hydroquinone diallyl ether, tetraallyloxyethane or other allyl or vinyl ethers of multifunctional alcohols, tetraethylene glycol diacrylate, triallylamine, trimethylolpropane diallyl ether, methylenebisacrylamide or divinylbenzene.

Particularly preferably, the crosslinking structures are derived from monomers of the formula (3), 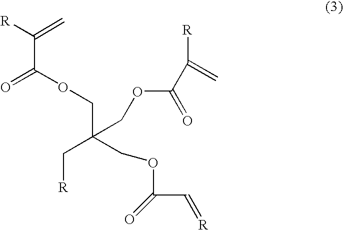
in which R is hydrogen, methyl or ethyl.

The preparation of the copolymers on which the dispersion concentrates prepared according to the process of the invention are based takes place as described in EP 1 116 733 and EP 1 028 129, by dissolving or dispersing the monomers corresponding to the repeat structural units of the formulae (1) and (2) in a protic solvent, adding one or more crosslinkers with at least two olefinic double bonds to this solution or dispersion, and starting the polymerization in a manner known per se, e.g. by adding a free-radical-forming compound.

In a preferred embodiment, the polymerization is carried out as a precipitation polymerization.

The acryloyldimethyltaurates may be the inorganic or organic salts of acryloyidimethyltauric acid (acrylamidopropyl-2-methyl-2-sulfonic acid). Preference is given to using the Li⁺, Na⁺, K⁺, Mg⁺⁺, Ca⁺⁺, Al⁺⁺⁺ and/or NH₄⁺ salts.

The degree of neutralization of the acryloyidimethyltauric acid can be between 0 and 100%, particular preference being given to a degree of neutralization of more than 80%.

Besides the copolymer, the concentrates or dispersion concentrates prepared by the process according to the invention also comprise one or more emulsifiers and/or a solvent or solvent mixture in the stated amount. If emulsifiers are used as the sole component II), the proportion of the solvent or solvent mixture is thus 0% and, accordingly, the proportion of the emulsifiers is 0% when the component II) consists only of a solvent or solvent mixture. Preference is given to using a mixture of emulsifier and solvent or solvent mixture as second component.

Suitable emulsifiers are addition products of from 0 to 30 mol of alkylene oxide, in particular ethylene oxide, propylene oxide, butylene oxide, onto linear fatty alcohols having 8 to 22 carbon atoms, onto fatty acids having 12 to 22 carbon atoms, onto alkylphenols having 8 to 15 carbon atoms in the alkyl group and onto sorbitan esters; (C₁₂-C₁₈)-fatty acid mono- and diesters of addition products of from 0 to 30 mol of ethylene oxide onto glycerol; glycerol mono- and diesters and sorbitan mono- and diesters of saturated and unsaturated fatty acids having 6 to 22 carbon atoms and optionally the ethylene oxide addition products thereof; addition products of from 15 to 60 mol of ethylene oxide onto castor oil and/or hydrogenated castor oil; polyol and, in particular, polyglycerol esters, such as, for example, polyglycerol polyricinoleate and polyglycerol poly-12-hydroxystearate. Preference is given to liquid fatty acid esters which may either be ethoxylated (PEG-10 polyglyceryl-2 laurate) or nonethoxylated (polyglyceryl-2 sesquiisostearate).

Preferred emulsifiers are sorbitol esters prepared by reacting sorbitol with fatty acid methyl esters or fatty acid triglycerides. The fatty acid radical in the fatty acid methyl esters and fatty acid triglycerides generally contains 8 to 22 carbon atoms and can be straight-chain or branched, saturated or unsaturated.

Examples of these are palmitic acid, stearic acid, lauric acid, linoleic acid, linolenic acid, isostearic acid or oleic acid. Suitable fatty acid triglycerides are all natural animal or vegetable oils, fats and waxes, for example olive oil, rapeseed oil, palm kernel oil, sunflower oil, coconut oil, linseed oil, castor oil, soybean oil, optionally also in refined or hydrogenated form. Since these natural fats, oils and waxes are normally mixtures of fatty acids of varying chain length, this also applies to the fatty acid radicals in the sorbitol esters used according to the invention. The sorbitol esters used according to the invention can also be alkoxylated, preferably ethoxylated.

In addition, it is possible to use anionic emulsifiers, such as ethoxylated and nonethoxylated mono-, di- or triphosphoric esters, but also cationic emulsifiers, such as mono-, di- and trialkyl quats and their polymeric derivatives.

Likewise suitable are mixtures of compounds from two or more of these classes of substances.

As well as the polymer based on acryloyldimethyltauric acid, the concentrates prepared by the process according to the invention can comprise one or more solvents, preferably chosen from the group of hydrocarbons, ester oils, vegetable oils and silicone oils. The solvents used according to the invention include oils, such as hydrocarbon oils with linear or branched, saturated or unsaturated C₇-C₄₀-carbon chains, for example vaseline, dodecane, isododecane, cholesterol, lanolin, hydrogenated polyisobutylenes, docosanes, hexadecane, isohexadecane, paraffins and isoparaffins;
oils of vegetable origin, in particular liquid triglycerides, such as sunflower oil, corn oil, soybean oil, rice oil, jojoba oil, babusscu oil, pumpkin oil, grapeseed oil, sesame oil, walnut oil, apricot oil, macadamia oil, avocado oil, sweet almond oil, lady's smock oil, castor oil, olive oil, peanut oil, rapeseed oil and coconut oil;
oils of animal origin, preferably beef tallow, perhydrosqualene, lanolin;
synthetic oils, such as purcellin oil, linear and/or branched fatty alcohols and fatty acid esters, preferably Guerbet alcohols having 6 to 18, preferably 8 to 10, carbon atoms; esters of linear (C₆-C₁₃)-fatty acids with linear (C₆-C₂₀)-fatty alcohols; esters of branched (C₆-C₁₃)-carboxylic acids with linear (C₆-C₂₀)-fatty alcohols, esters of linear (C₆-C₁₈)-fatty acids with branched alcohols, in particular 2-ethylhexanol;
esters of linear and/or branched fatty acids with polyhydric alcohols (such as, for example, dimerdiol or trimerdiol) and/or Guerbet alcohols;
alcohol esters of C₁-C₁₀-carboxylic acids or C₂-C₃₀-dicarboxylic acids, C₁-C₃₀-carboxylic monoesters and polyesters of sugars, C₁-C₃₀-monoesters and polyesters of glycerol;
waxes, such as beeswax, paraffin wax or microwaxes, optionally in combination with hydrophilic waxes, such as, for example, cetylstearyl alcohol; fluorinated and perfluorinated oils;
monoglycerides of C₁-C₃₀-carboxylic acids, diglycerides of C₁-C₃₀-carboxylic acids, triglycerides of C₁-C₃₀-carboxylic acids, for example triglycerides of caprylic/capric acids, ethylene glycol monoesters of C₁-C₃₀-carboxylic acids, ethylene glycol diesters of C₁-C₃₀-carboxylic acids, propylene glycol monoesters of C₁-C₃₀-carboxylic acids, propylene glycol diesters of C₁-C₃₀-carboxylic acids, and also propoxylated and ethoxylated derivatives of the abovementioned classes of compounds.

The concentrates prepared by the process according to the invention can additionally also comprise 0 to 30% by weight, preferably 0 to 10% by weight, particularly preferably 0 to 5% by weight, of water.

The invention further also provides the concentrates obtainable by the process according to the invention.

The concentrates according to the invention are suitable as thickener, consistency-imparting agent, emulsifier, solubilizer, dispersant, slip agent, adhesive, conditioner and/or stabilizer—in an excellent manner for the formulation of cosmetic, pharmaceutical and dermatological compositions, in particular of oil-in-water emulsions in the form of creams, lotions, cleansing milk, cream gels, spray emulsions, e.g. body lotions, after sun lotions, sun screen compositions and deodorant sprays.

The advantage of these concentrates is that the above-defined copolymers are in a presentation form which permits simple preparation of cosmetic, pharmaceutical and dermatological preparations based on these copolymers. The concentrates according to the invention are surprisingly pourable and storage-stable despite their high content of copolymer.

The present invention therefore also provides cosmetic, pharmaceutical and dermatological preparations comprising a concentrate according to the invention.

The concentrates according to the invention are used in the cosmetic, pharmaceutical and dermatological preparations in amounts by weight such that polymer concentrations of from 0.01 to 10% by weight, preferably 0.1 to 5% by weight, particularly preferably 0.5 to 3% by weight, based on the finished compositions, result.

Such preparations may comprise anionic, cationic, nonionic, zwitterionic and/or amphoteric surfactants, and also further auxiliaries and additives, cationic polymers, film formers, superfatting agents, stabilizers, biogenic active ingredients, glycerol, preservatives, pearlizing agents, dyes and fragrances, solvents, opacifiers, and also protein derivatives, such as gelatin, collagen hydrolysates, natural and synthetic-based polypeptides, egg yolk, lecithin, lanolin and lanolin derivatives, fatty alcohols, silicones, deodorizing agents, substances with a keratolytic and keratoplastic action, enzymes and carrier substances. Furthermore, antimicrobially active agents can be added to the compositions according to the invention.

In addition, such preparations can comprise organic solvents. In principle, suitable organic solvents are all mono- or polyhydric alcohols. Preference is given to using alcohols having 1 to 4 carbon atoms, such as ethanol, propanol, isopropanol, n-butanol, isobutanol, tert-butanol, glycerol and mixtures of said alcohols. Further preferred alcohols are polyethylene glycols with a relative molecular mass below 2000. In particular, a use of polyethylene glycol with a relative molecular mass between 200 and 600 and in amounts up to 45% by weight and of polyethylene glycol with a relative molecular mass between 400 and 600 in amounts of from 5 to 25% by weight is preferred. Further suitable solvents are, for example, triacetin (glycerol triacetate) and 1-methoxy-2-propanol. Short-chain anionic surfactants, in particular arylsulfonates, for example cumene- or toluenesulfonate, have a hydrotropic effect.

The following examples of concentrates containing polymers based on acryloyidimethyltauric acid or salts thereof are intended to illustrate the subject-matter of the invention in more detail without limiting it thereto. The percentages given are % by weight.

### EXAMPLE A

### From Table (High Emulsifier Concentration)

500 g of tert-butanol, 80 g of acryloyldimethyltauric acid are initially introduced into a 1 liter flat-flange flask with temperature sensor, reflux condenser, precision-ground glass stirrer and pH control. The mixture is then neutralized by introducing gaseous ammonia, and 5 g of N-vinylpyrrolidone vinylpyrrolidone and 2.0 g of trimethylolpropane triacrylate (crosslinker) are added to the reaction mixture. The reaction mixture is then rendered inert by introducing N₂, heated to 60° C. and the reaction is started after 30 minutes by adding 2 g of dilauroyl peroxide. An exothermic reaction results in which the internal temperature increases by several degrees. After about 10 minutes, the resulting polymer precipitates out, which is evident from a steady increase in the solution viscosity. At the end of the exothermic phase (about 20-30 minutes), the reaction mixture is heated to the boiling temperature and after-boiled for 2 hours to complete the reaction. During this time, the viscosity of the solution decreases again. Afterwards, the reflux condenser is replaced by a distillation bridge. Then, 90 g of Hostaphat KL 340D, 75 g of Emulsogen SRO, 20 g of mineral oil (low viscosity) and 20 g of isopropyl palmitate are added to the polymer suspension, and the major part of the tert-butanol is then removed by distillation with good stirring. By applying a vacuum, the tert-butanol residues are removed from the mixture. It must be ensured that although the applied vacuum permits the removal of the tert-butanol by distillation, it does not exceed the corresponding boiling temperature of the solvent at this pressure. After the tert-butanol has been separated off, the mixture is cooled and the product is removed from the flask.

### EXAMPLE G

### From Table (Low Emulsifier Concentration)

400 g of tert-butyl and 80 g of acryloyidimethyltauric acid are initially introduced into a 1 liter flat-flange flask with temperature sensor, reflux condenser, precision-ground glass stirrer and pH control. The mixture is then neutralized by introducing gaseous ammonia, and 15 g of N-vinylformamide and 1.65 g of TMPTA (trimethylolpropane triacrylate) are added to the reaction mixture. The reaction mixture is then rendered inert by introducing N₂, heated to 60° C. and the reaction is started after 30 minutes by adding 1 g of dilauroyl peroxide. An exothermic reaction results in which the internal temperature increases by several degrees. After about 10 minutes, the resulting polymer precipitates out, which is evident from a steady increase in the solution viscosity. At the end of the exothermic phase (about 20-30 minutes), the reaction mixture is heated to the boiling temperature and after-boiled for 2 hours to complete the reaction. During this time, the viscosity of the solution decreases again. Afterwards, the reflux condenser is replaced by a distillation bridge. Then, 7.5 g of Hostacerin DGI, 5 g of Hostaphat KL 340D, 73 g of mineral oil (low viscosity) and 73 g of isopropyl palmitate are added to the polymer suspension, and the major part of the tert-butanol is then removed by distillation with good stirring. By applying a vacuum, the tert-butanol residues are removed from the mixture. It must be ensured that although the applied vacuum permits the removal of the tert-butanol by distillation, it does not exceed the corresponding boiling temperature of the solvent at this pressure. After the tert-butanol has been separated off, the mixture is cooled and the product is removed from the flask.

Various concentrates with different emulsifier and oil concentrations were preparated.

Table 1 shows examples of concentrates which are flowable and storage-stable (sedimentation upon storage at 25° C.; 3 weeks).

TABLE 1

| | Dispersion concentrate | | | | | | | |
|---|---|---|---|---|---|---|---|---|
| | A | B | C | D | E | F | G | H |
| Amount of polymer | 36 | 36 | 36 | 30 | 36 | 36 | 36 | 30 |
| Hostacerin DGI | — | 30 | 3 | 51 | — | 30 | 3 | 51 |
| Hostaphat KL 340 D | 18 | 18 | 2 | 13 | 18 | 18 | 2 | 13 |
| Emulsogen SRO | 30 | — | — | — | 30 | — | — | — |
| Mineral oil, low-viscosity | 8 | — | 29.5 | 6 | 8 | — | 29.5 | 6 |
| Isopropyl palmitate | 8 | — | 29.5 | — | 8 | — | 29.5 | — |
| Myritol 318 | — | 16 | — | — | — | 16 | — | — |

The figures given in table 1 are % by weight. The concentrates B, D, E, F and H were prepared analogously to A, and the concentrate C was prepared analogously to G, but varying the emulsifiers and oils.

| | INCI name |
|---|---|
| Hostacerin DGI | Polyglyceryl-2 Sesquiisostearate |
| Hostaphat KL 340 D | Trilaureth-4 Phosphate |
| Emulsogen SRO | Rapeseed Oil Sorbitol Esters |
| | Mineral Oil, low-viscosity |
| | Isopropyl Palmitate |
| Myritol 318 | Caprylic/Capric Triglyceride |

Examples of use of the concentrates according to the invention in the preparation of cosmetic preparations. The percentages are % by weight.

### EXAMPLE 1

### Moisturizing Lotion

| | | |
|---|---|---|
| A | Almond oil | 7.00% |
| | Cyclomethicones | 5.00% |
| B | Dispersion concentrate C | 4.00% |
| C | Glycerol | 7.00% |
| | Water | ad 100% |
| | Preservative | q.s. |
| D | Fragrance | 0.30% |

Preparation
I Mix A and B.
II Stir solution of C into I.
III Add D to II.
IV Homogenize
V pH 5.5

### EXAMPLE 2

### Sunscreen Lotion

| | | |
|---|---|---|
| A | Vaseline | 5.00% |
| | Paraffin oil | 10.00% |
| | Dispersion concentrate A | 2.00% |
| | Tocopheryl acetate | 1.00% |
| | Octyl methoxycinnamate | 2.00% |
| | Parasol 1789 | 0.20% |
| B | Ethanol | 10.00% |
| C | Butylene glycol | 5.00% |
| | Water | ad 100% |

Preparation
I A and C are heated separately to 75° C., then combined and cooled with stirring to 65° C., homogenized and cooled further to 35° C.,
II stir B into I, homogenize and cool to room temperature

### EXAMPLE 3

### O/W Skin Milk

| | | |
|---|---|---|
| A | Isopropyl palmitate | 4.00% |
| | Almond oil 5.00% | 4.00% |
| | Wheatgerm oil | 1.00% |
| | ® Cetiol SN (Henkel) | 8.00% |
| | Cetearyl isononanoate | |
| B | Dispersion concentrate G | 1.50% |
| C | Water | ad 100% |
| D | Fragrances | 0.30% |

Preparation
I Add B to A with stirring
II Stir C and D into I
III Homogenize emulsion

1. A process for the preparation of concentrates in liquid or liquid-disperse form comprising
I) 10 to 80% by weight of a copolymer comprising
a) 1 to 50% by weight of a repeat structural unit of the formula (1) 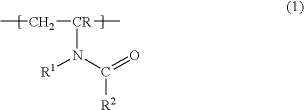
where R, R¹ and R² are identical or different and are hydrogen, a linear or branched alkyl group having in each case 1 to 30 carbon atoms, a linear or branched alkenyl group having in each case 2 to 30 carbon atoms, or R¹ and R² together are a C₂-C₉-alkylene group,
b) 49.99 to 98.99% by weight of the repeat structural unit of the formula (2) 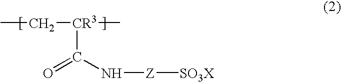
in which R³ is hydrogen, methyl or ethyl, Z is C₁-C₈-alkylene and X is an ammonium, alkali metal or alkaline earth metal ion, and
c) 0.01 to 8% by weight of crosslinking structures formed from monomers with at least two olefinic double bonds,
II) 20 to 90% by weight of one or more emulsifiers a solvent, solvent mixture or mixtures thereof, and
III) 0 to 30% by weight of water,
wherein the concentrate is made by a process comprising the steps of
a) free radically copolymerizing the components a), b) and c) in a polymerization medium which behaves largely inertly with regard to free-radical polymerization reactions and permits the formation of high molecular weights,
b) adding a higher-boiling solvent, solvent mixture, one or more emulsifiers and mixtures thereof to the mixture of polymer and polymerization medium, where the boiling point of the higher-boiling solvent or solvent mixture is at least 10° C. higher than that of the polymerization medium used for the polymerization and
c) removing the polymerization medium.

2. The process as claimed in claim 1, wherein the copolymer comprises 2 to 30% by weight of structural units of the formula (1), 69.5 to 97.5% by weight of structural units of the formula (2), and 0.2 to 3% by weight of crosslinking structures formed from monomers with at least two olefinic double bonds.

3. The process as claimed in claim 1, wherein the copolymer has crosslinking structures formed from monomers with at least two olefinic double bonds and are derived from acrylic or methacrylic allyl ester, dipropylene glycol diallyl ether, polyglycol diallyl ether, triethylene glycol divinyl ether, hydroquinone diallyl ether, tetraallyloxyethane, allyl or vinyl ethers of multifunctional alcohols, tetraethylene glycol diacrylate, triallylamine, trimethylolpropane diallyl ether, methylenebisacrylamide or divinylbenzene.

4. The process as claimed in claim 1, wherein the copolymer has crosslinking structures derived from monomers of the formula (3), 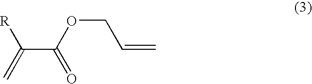
in which R is hydrogen, methyl or ethyl.

5. The process as claimed in claim 1, wherein the concentrate comprises 20 to 60% by weight of the copolymer.

6. The process as claimed in claim 1, wherein the concentrate comprises 30 to 80% by weight of the one or more emulsifiers, solvent, solvent mixture or mixtures thereof.

7. The process as claimed in claim 10, wherein the concentrate comprises 0 to 10% by weight of water.

8. A concentrate made by a process as claimed in claim 1.

9. A cosmetic, pharmaceutical or dermatological preparation comprising a concentrate as claimed in claim 8.

10. The process as claimed in claim 1, wherein the adding step further comprises adding water to the polymer and polymerization medium.

11. The process as claimed in claim 1, wherein the removing step further comprises removing the polymerization medium at pressure lower than atmospheric pressure.

12. The process as claimed in claim 1, wherein the removing step further comprises removing the polymerization medium at a temperature greater than room temperature.

13. The process as claimed in claim 2, wherein the structural units of the formula (I) are derived from N-vinylpyrrolidone.

14. The process as claimed in claim 2, wherein the structural units of the formula (2) are derived from ammonium salt of 2-acrylamino-2-methylpropanesulfonic acid.
